(19) United States
(12) Patent Application Publication
(10) Pub. No.: US 2007/0177219 A1
(43) Pub. Date: Aug. 2, 2007

(54) Disposal apparatus, disposal system, and disposal method

(75) Inventors: Kengo Shinozaki, Kanagawa (JP); Hitoshi Suzuki, Kanagawa (JP); Ryuuichi Shiraishi, Kanagawa (JP); Shunsuke Hamasuna, Kanagawa (JP); Hiroyoshi Uejo, Kanagawa (JP); Takashi Sugawara, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/519,827

(22) Filed: Sep. 13, 2006

(30) Foreign Application Priority Data
Jan. 31, 2006 (JP) 2006-023502

(51) Int. Cl. H04N 1/23

(52) U.S. Cl. 358/304; 358/474

(57) ABSTRACT

A disposal apparatus comprises: a disposal processing section that disposes of a recording medium; an authentication information acquiring section that acquires authentication information to be used for authenticating a user of the disposal apparatus; a disposal processing control section that permitting or prohibiting disposal of the recording medium by the disposal processing section based on the authentication information acquired by the authentication information acquiring section.

### BACKGROUND

(i) Technical Field

The present invention relates to a disposal apparatus, a disposal system, and a disposal method which are suitable for use in management of recording media such as documents.

(ii) Related Art

In general, many secret documents that should be kept secret from outsiders (e.g., parties outside the company) are handled in offices of companies and public organizations such as city halls. To prevent leakage to third parties, the originals of such secret documents are kept in storage under strict management. On the other hand, secret documents that are no longer necessary are disposed of with a shredder or the like. Things to be disposed of are not limited to documents; in recent years, it has become possible to dispose of such recording media as CD-Rs, DVD-Rs, and IC cards with a shredder.

In many cases, compulsory storage periods are specified for secret documents relating to accounting (bills, receipts, statements of accounts, etc.). Therefore, before disposing of a secret document by shredding, a person in charge needs to confirm, using a register of originals or the like, that disposal of the secret document he or she is going to dispose of is really appropriate.

However, in the case of disposing of a large number of secret documents, the work of disposing of the secret documents while checking their respective storage periods one by one is very troublesome and takes long time. Furthermore, there is a risk that a secret document whose storage period has not expired yet may be discarded erroneously due to a human check error.

### SUMMARY

According to an aspect of the invention, a disposal apparatus comprises: a disposal processing section that disposes of a recording medium; an authentication information acquiring section that acquires authentication information to be used for authenticating a user of the disposal apparatus; and a disposal processing control section that permitting or prohibiting disposal of the recording medium by the disposal processing section based on the authentication information acquired by the authentication information acquiring section.

### BRIEF DESCRIPTION OF THE DRAWINGS

Exemplary embodiments of the present invention will be described in detail based on the following figure, wherein:

FIG. 1 shows the configuration of a document management system according to an embodiment of the present invention;

FIG. 2 is a block diagram showing an exemplary configuration of a document generation apparatus;

FIG. 3 is a block diagram showing an exemplary configuration of a document management apparatus;

FIG. 4 schematically shows an exemplary mechanism of a manual-feed-type document disposal apparatus;

FIG. 5 is a top view of a document tray unit;

FIG. 6 is a block diagram showing an exemplary configuration of the manual-feed-type document disposal apparatus;

FIG. 7 illustrates an exemplary manner of generation of a document;

FIG. 8 shows an exemplary document management table;

FIG. 9 is a flowchart of a processing procedure of the manual-feed-type document disposal apparatus;

FIG. 10 shows an exemplary user information table; and

FIG. 11 shows the configuration of a document management system according to another embodiment of the invention.

### DETAILED DESCRIPTION

Exemplary embodiments of the present invention will be hereinafter described in detail with reference to the drawings.

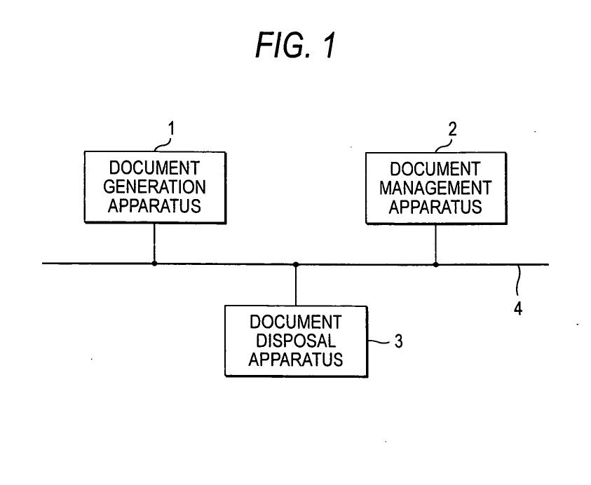

FIG. 1 shows the configuration of a document management system according to an exemplary embodiment of the invention. The illustrated document management system is composed of a document generation apparatus 1, a document management apparatus 2, and a document disposal apparatus 3, which are connected to a common network 4.

The document generation apparatus 1 generates a document (paper document) to which a document ID is attached. The document management apparatus 2 performs various kinds of management processing on documents generated by the document generation apparatus 1. The document disposal apparatus 3 performs disposal processing on documents generated by the document generation apparatus 1 and other documents. The network 4 is configured by using a LAN (local area network) or a WAN (wide area network), for example.

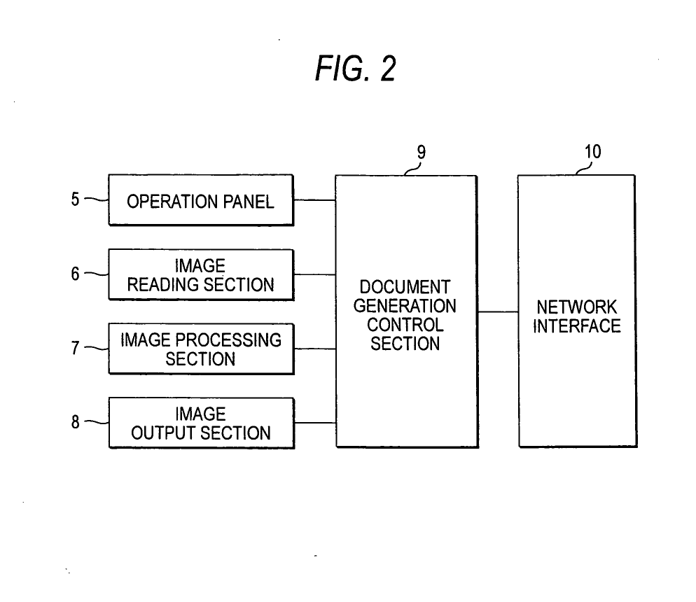

FIG. 2 is a block diagram showing an exemplary configuration of the document generation apparatus 1. The document generation apparatus 1 is configured by using a digital copier, a digital multi-function machine (multifunctional copier), or the like. The document generation apparatus 1 is composed of an operation panel 5, an image reading section 6, an image processing section 7, an image output section 8, a document generation control section 9, and a network interface 10.

The operation panel 5 serves as a user interface through which a user of the document generation apparatus 1 inputs various kinds of information and on which various kinds of information are displayed for the user. For example, the operation panel 5 is composed of an input unit having various buttons, switches, keys, etc. and a display unit which is a liquid crystal panel with a touch panel.

The image reading section 6 optically reads images of a document as a subject of reading. The image reading section 6 generates image data (scanning data) corresponding to a document sheet image by applying light to the surface of a document sheet set on a transparent document table (platen glass) and forming an image of reflection light returning from the document sheet surface on the photodetecting surface of a reading sensor (CCD sensor or the like) via an image forming optical system including mirrors and lenses. During that course, the document sheet surface is scanned for reading as the image forming optical system is moved.

The image processing section 7 performs prescribed image processing (e.g., color conversion, color correction, gradation correction, enlargement/reduction, image rotation, and screen generation) on the image data produced by reading the document with the image reading section 6.

The image output section 8 prints the image data produced by the reading by the image reading section 6 and subjected to the image processing by the image processing section 7 on recording media such as sheets. The image output section 8 prints the image data by an electrophotographic method, for example.

The document generation control section 9 controls various operations relating to document generation. The document generation control section 9 controls operations of the operation panel 5, the image reading section 6, the image processing section 7, and the image output section 8 according to control programs given in advance.

The network interface 10 is a communication interface via which the document generation apparatus 1 exchanges data with other apparatus (including the document management apparatus 2 and the document disposal apparatus 3) over the network 4. Data exchange via the network interface 10 is controlled by the document generation control section 9.

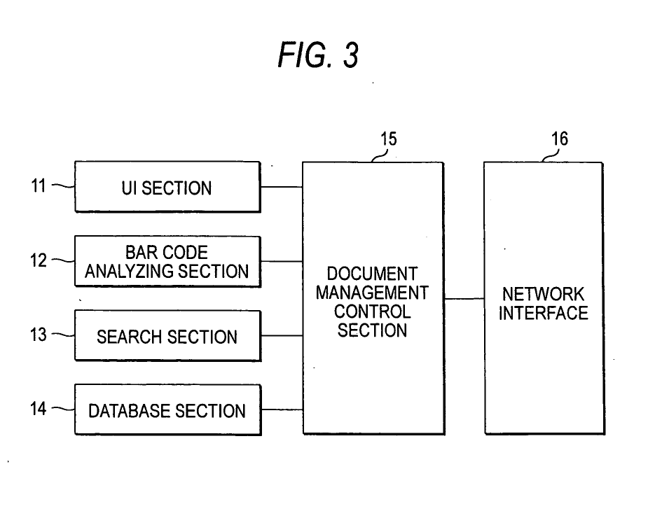

FIG. 3 is a block diagram showing an exemplary configuration of the document management apparatus 2. The document management apparatus 2 is configured by using a personal computer, for example. The document management apparatus 2 is composed of a user interface section (UI section) 11, a bar code analyzing section 12, a search section 13, a database section 14, a document management control section 15, and a network interface 16.

The user interface section 11 is a user interface through which a user of the document management apparatus 2 inputs various kinds of information and on which various kinds of information are displayed for the user. For example, the user interface section 11 is composed of input devices such as a keyboard and a mouse and a display device such as a liquid crystal display.

The bar code analyzing section 12 analyzes and decodes a bar code that is contained in image data (scanning data). A bar code to be analyzed by the bar code analyzing section 12 is one that is contained in image data obtained when images of a document with a bar code are read by the document generation apparatus 1. This bar code is information including at least a document ID. In general, bar codes are generally classified into one-dimensional bar codes in which pieces of information are arranged only in one direction and two-dimensional bar codes in which pieces of information are arranged in two orthogonal directions. Bar codes of both types can be used in practicing the invention. However, where it is desired to have a bar code contain not only a document ID but also other various kinds of information and data, it is desirable to use a two-dimensional bar code having a larger data capacity. This exemplary embodiment employs, as an example, a QR code (registered trademark) which is a kind of two-dimensional bar code and is now widespread.

The search section 13 searches data accumulated in the database section 14. The database section 14 accumulates various kinds of data. For example, the database section 14 is configured by using a hard disk drive.

The document management control section 15 controls various operations relating to document management. The document management control section 15 controls operations of the user interface section 11, the bar code analyzing section 12, the search section, and the database section 14 according to control programs given in advance.

The network interface 16 is a communication interface via which the document management apparatus 2 exchanges data with other apparatus (including the document generation apparatus 1 and the document disposal apparatus 3) over the network 4. Data exchange via the network interface 16 is controlled by the document management control section 15.

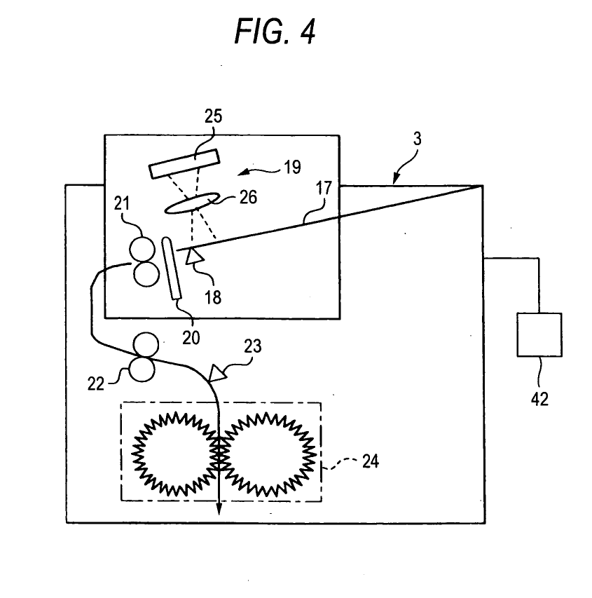

FIG. 4 schematically shows an exemplary mechanism of a manual-feed-type document disposal apparatus 3. The document disposal apparatus 3, which is configured by using a shredder, for example, is equipped with a document tray unit 17, an insertion sensor 18, a reading optical system 19 of a bar code reader, a stopper 20, pairs of feed rolls 21 and 22, a passage sensor 23, and a shredder unit 24.

The document tray unit 17 is a unit on which a document as a subject of disposal is placed. The document tray unit 17 is inclined from the horizontal plane so as to descend gradually toward the stopper 20. The back side (lower side) of the document tray unit 17, together with the insertion sensor 18, the reading optical system 19, the stopper 20, and the feed rolls 21, is covered with a cover member (not shown).

The insertion sensor 18 detects a document that has been inserted to a prescribed reading position on the document tray unit 17. For example, the insertion sensor 18 is a reflection-type optical sensor having a light-emitting element and a photodetector. The insertion sensor 18 is rendered in an on state when a document exists at its sensing position and in an off state when no document exists at the sensing position.

The reading optical system 19 of the bar code reader is configured in such a manner that light emitted from a light source (not shown) is applied to a bar code recording portion of a document as a subject of disposal and an area sensor 25 captures a bar code image by detecting reflection light via a lens 26. The bar code recording portion is a portion of a document surface where a bar code is recorded which includes a document ID and other information. The bar code recording portion is located at a corner position of a document and its dimensions are predetermined.

The stopper 20 has a long plate-like structure, for example, and is disposed between the insertion sensor 18 and the feed rolls 21. The stopper 20 opens or closes a document transport passage formed by the pairs of feed rolls 21 and 22 at its entrance. In a closed state, the stopper 20 is projected so as to interrupt a document path from the document tray unit 17 to the feed rolls 21. Therefore, in this state, if a user tries to insert a document inward on the document tray unit 17, the head of the document butts against the stopper 20. In contrast, in an open state, the stopper 20 is retracted from the document path from the document tray unit 17 to the feed rolls 21. Therefore, if a user tries to insert a document inward on the document tray unit 17, the head of the document butts into the nip portion of the feed rolls 21.

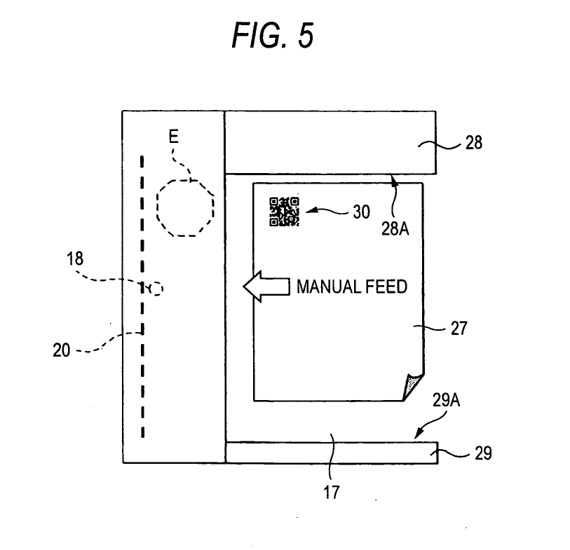

FIG. 5 is a top view of the document tray unit 17. The document tray unit 17 is equipped with insertion guides 28 and 29 on both sides of a passage along which a document 27 is inserted manually (the insertion direction is indicated by an arrow). The insertion guides 28 and 29 have respective guide surfaces 28A and 29A which are parallel with the document-insertion direction. Whereas the insertion guide 28 is fixed, the insertion guide 29 can be moved in the document width direction (vertical direction in FIG. 5) if necessary. The document 27 as a subject of disposal is inserted on the document tray unit 17 in the arrow direction with an orientation that a bar code recording portion 30 is located at a head-side corner position. At this time, to position the document 27 in the direction perpendicular to the insertion direction, one sideline of the document 27 is fully brought into contact with the guide surface 28A of the insertion guide 28.

As a result, in a state that the head of the document 27 is in contact with the stopper 20 as a result of manual insertion by a user, the bar code recording portion 30 is positioned inside a code reading area E of the bar code reader. The insertion sensor 18 is disposed immediately upstream of the stopper 20 in the document insertion direction. Therefore, the insertion sensor 18 is switched from an off state to an on state immediately before the head of the document 27 butts against the stopper 20 as it is inserted manually by a user. Therefore, on-timing of the insertion sensor 18 indicates a time point when the bar code recording portion 30 of the document 27 is put in the code reading area E.

The feed rolls 21 rotate while nipping a document that has been introduced by opening the stopper 20, and thereby transport the document along a document transport passage, which is formed by a transport guide member (chute or the like; not shown). The feed rolls 22 rotate while nipping a document that has been transported by the feed rolls 21, and thereby transport the document to the shredder unit 24 along the document transport passage.

The passage sensor 23 is disposed at a halfway position (approximately at the center) of the document transport passage from the feed rolls 22 to the shredder unit 24 and detects a passage of a document. For example, the passage sensor 23 is a reflection-type optical sensor having a light-emitting element and a photodetector. The passage sensor 23 is rendered in an on state if a document exists at the sensing position and in an off state if no document exists at the sensing position. Therefore, the passage sensor 23 is switched from an off state to an on state at the same time as the head of a document passes its sensing position. When the tail of the document thereafter passes the sensing position, the passage sensor 23 is switched from the on state to an off state.

The shredder unit 24 shreds a document fed by the feed rolls 22 while pulling the document into itself in one direction (indicated by an arrow). The shredder unit 24 can shred plural document sheets (e.g., a bundle of about 20 A4-size plain sheets) together. Furthermore, the shredder unit 24 can shred even stapled document sheets as they are (i.e., in a state that staples are not removed).

The document disposal apparatus 3 is equipped with an IC card reader 42 for authentication of a user who is going to use the document disposal apparatus 3. Each user has an IC card which contains his or her authentication information, and authentication processing for personal identification is performed when a user holds an IC card over the IC card reader 42. The authentication information acquiring section for acquiring authentication information to be used for authenticating a user of the document disposal apparatus 3 is not limited to the one based on the user authentication technique using an IC card and may be one based on a password authentication technique using a password that consists of alphanumeric characters, symbols, etc., one based on a face/iris authentication technique using a camera (CCD camera) that is provided in the document disposal apparatus 3 or a PC connected to the document disposal apparatus 3, or one based on a fingerprint/vein pattern authentication technique using a recognition device that is provided in the document disposal apparatus 3 or a PC connected to the document disposal apparatus 3.

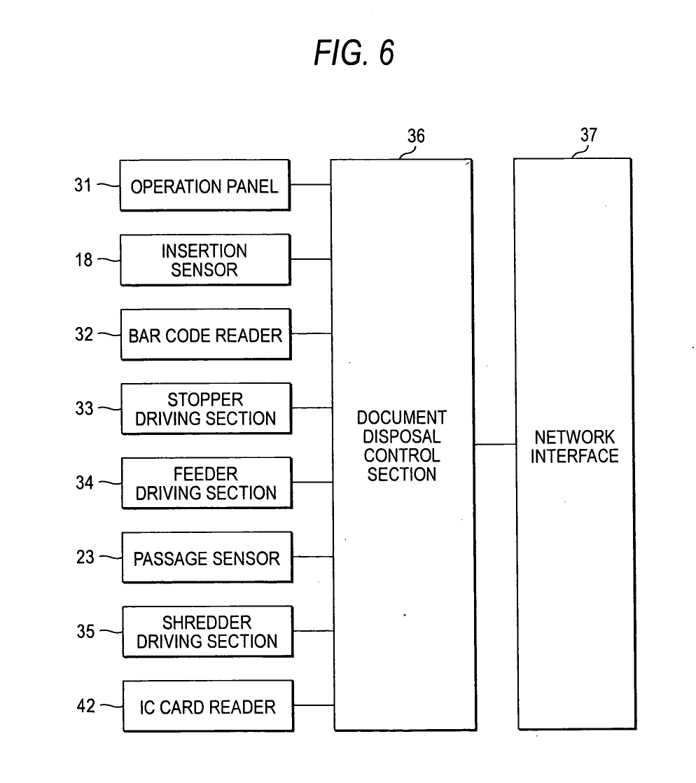

FIG. 6 is a block diagram showing an exemplary configuration of the manual-feed-type document disposal apparatus 3. The document disposal apparatus 3 is equipped with, in addition to the above-described components, an operation panel 31, a bar code reader 32, a stopper driving section 33, a feeder driving section 34, a shredder driving section 35, a document disposal control section 36, and a network interface 37.

The operation panel 31 is manipulated by a user who uses the document disposal apparatus 3. For example, the operation panel 31 is configured by using manipulation buttons (e.g., a start button and a stop button) and a display panel which displays an operation status of the document disposal apparatus 3 and various messages including manipulation guidance messages.

The bar code reader 32 optically reads, using the above-described reading optical system 19, a bar code that is attached to a document by printing, and outputs original information (data) contained in the bar code provided in the document.

The stopper driving section 33 opens (retracts) or closes (projects) the stopper 20. For example, the stopper driving section 33 may be configured by using an electromagnetic plunger as a drive source.

The feeder driving section 34 rotates the above-described feed rolls 21 and 22. For example, the feeder driving section 34 may be configured by using a motor as a drive source.

The shredder driving section 35 rotates the above-described shredder unit 24. For example, the shredder driving section 35 may be configured by using a motor as a drive source.

The document disposal control section 36 controls various operations relating to document disposal. The document disposal control section 36 controls operations of the bar code reader 32, the stopper driving section 33, the feeder driving section 34, and the shredder driving section 35 according to control programs given in advance. The above-described insertion sensor 18 and passage sensor 23 are electrically connected to the document disposal control section 36.

The network interface 37 is a communication interface via which the document disposal apparatus 3 exchanges data with other apparatus (including the document generation apparatus 1 and the document management apparatus 2) over the network 4. Data exchange via the network interface 37 is controlled by the document disposal control section 36.

Next, a document management method using the above-configured document management system will be described. Documents to which the invention is directed are ones generated by the document generation apparatus 1 while being assigned unique document IDs individually. The document ID may consist of only numerals or may be formed by combining numerals, alphabetical characters, symbols, etc. as appropriate. A specific management method that is directed to a case of handling documents to serve as vouchers for an accounting audit, a tax audit, etc. will be described below.

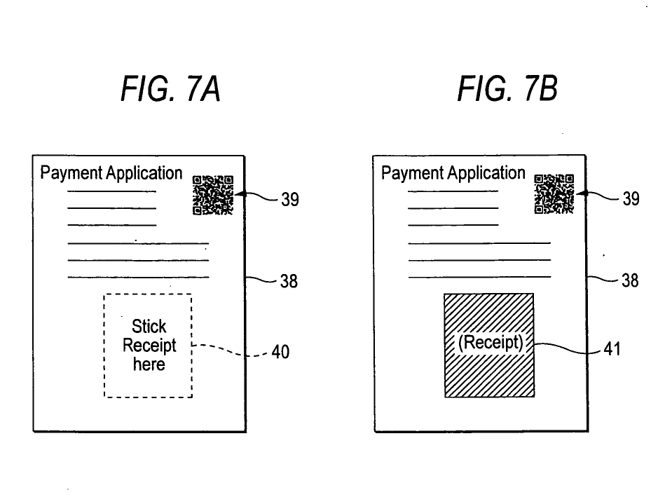

First, for example, a form of a payment application document 38 as shown in FIG. 7(A) is generated by inputting document data (electronic data) with a bar code to serve as a document template to the document generation apparatus 1 and printing the document data on a sheet with the image output section 8. For example, the document data may be generated by the document management apparatus 2 and sent from the document management apparatus 2 to the document generation apparatus 1 over the network 4. Alternatively, the document data may be generated separately by a server apparatus for document data generation and sent from the server apparatus to the document generation apparatus 1 over the network 4.

A QR code 39 which contains a document ID to be assigned to a payment application document 38 and other information is thereby attached, by printing, at a corner position, to the form of a payment application document 38 generated by the document generation apparatus 1. That is, a payment application document 38 to be generated by the document generation apparatus 1 corresponds to a “document to which a document ID is attached.” The form of a payment application document 38 has a region 40 to which a receipt is to be stuck. As shown in FIG. 7(B), an applicant generates an original of a payment application document 38 by sticking a receipt 41 to the form of a payment application document 38 and, if necessary, adding statements and putting his or her seal thereto.

After generating the payment application document 38 in the above manner, the applicant sets it on the document table of the document generation apparatus 1 and causes the image reading section 6 to read its image. Alternatively, the generated information is sent from the document generation apparatus 1 to the document management apparatus 2 over the network 4 and registered as data. The image data that have been produced by reading the payment application document 38 with the image reading section 6 are sent to the document management apparatus 2 over the network 4. The original of the payment application document 38 that has been read is filed, for example, and put in storage.

Receiving the image data (scanning data) of the payment application document 38 from the document generation apparatus 1, the document management apparatus 2 stores the image data in the database section 14 and acquires decoded information of the document ID assigned to the payment application document 38 by analyzing the QR code image contained in the received image data with the bar code analyzing section 12. The document management control section 15 registers the thus-acquired document ID in a document management table, which is stored in the database section 14.

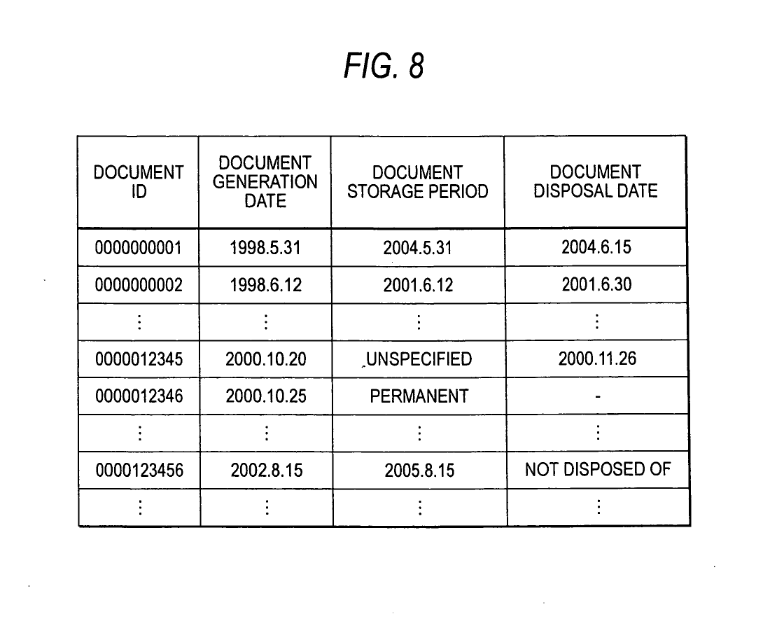

FIG. 8 shows an exemplary document management table. As shown in FIG. 8, a “document ID,” a “document generation date,” a “document storage period,” and a “document disposal date” are registered in the document management table so as to be correlated with each other. The “document ID” may be one obtained by decoding a QR code with the bar code analyzing section 12 or one that was assigned to the document by the document management apparatus 2 itself or a separate server apparatus when it generated document data with a bar code (mentioned above). The “document generation date” is a date of generation of the document. In this exemplary embodiment, a date on which image data produced by reading the document such as the payment application document 38 with the document generation apparatus 1 are sent to the document management apparatus 2 is registered as a “document generation date.”

The “document storage period” is the last date of a period in which the document should be kept in storage. Each document whose document ID is registered in the document management table should be kept in storage until the document storage period expires. If the “document storage period” registered is “unspecified,” the document can be disposed of anytime. If the “document storage period” registered is “permanent,” disposal of the document is always prohibited.

For example, if information for setting of a “document storage period” is contained, in addition to the document ID, in the QR code that is printed on the form of a payment application document 38, a “document storage period” can be set automatically on the basis of decoded information that is produced by the bar code analyzing section 12. More specifically, if information to the effect that the document storage period of the payment application document 38 should be set at 6 years is contained in the QR code, a date that is 6 years after the date of generation of the payment application document 38 can be set automatically as a “document storage period.”

In general, as for receipts, the storage period is determined in accordance with the amount of money received. Therefore, if information indicating the amount of money received of a receipt to be stuck to the form of a payment application document 38 is contained in the QR code, a storage period of the receipt can be determined automatically from that information and registered as a “document storage period” in the document management table. Furthermore, a user can manually change or set a “document storage period” registered or to be registered in the document management table using the user interface section 11 of the document management apparatus 2.

The “document disposal date” is a date when the document was disposed of. Documents are disposed of by the document disposal apparatus 3. Therefore, a date when a notice of completion of disposal of a document (hereinafter also referred to as “disposal completion notice”) is sent from the document disposal apparatus 3 to the document management apparatus 2 with designation of a document ID of a document that has been disposed of is registered in the document management table as a “document disposal date.”

Each of the “document generation date,” “document storage period,” and “document disposal date” among the registration items of the document management table may be registered in the form of a date and time. It is preferable that a user ID of a user who has generated a document using the document generation apparatus 1 be registered in the document management table as information indicating a document generator or that a user ID of a user who has disposed of a document using the document disposal apparatus 3 be registered in the document management table as information indicating a document disposer. In such a case, ID information of the user who has generated or disposed of the document can be acquired by utilizing an existing user authentication technique (e.g., one using an IC card).

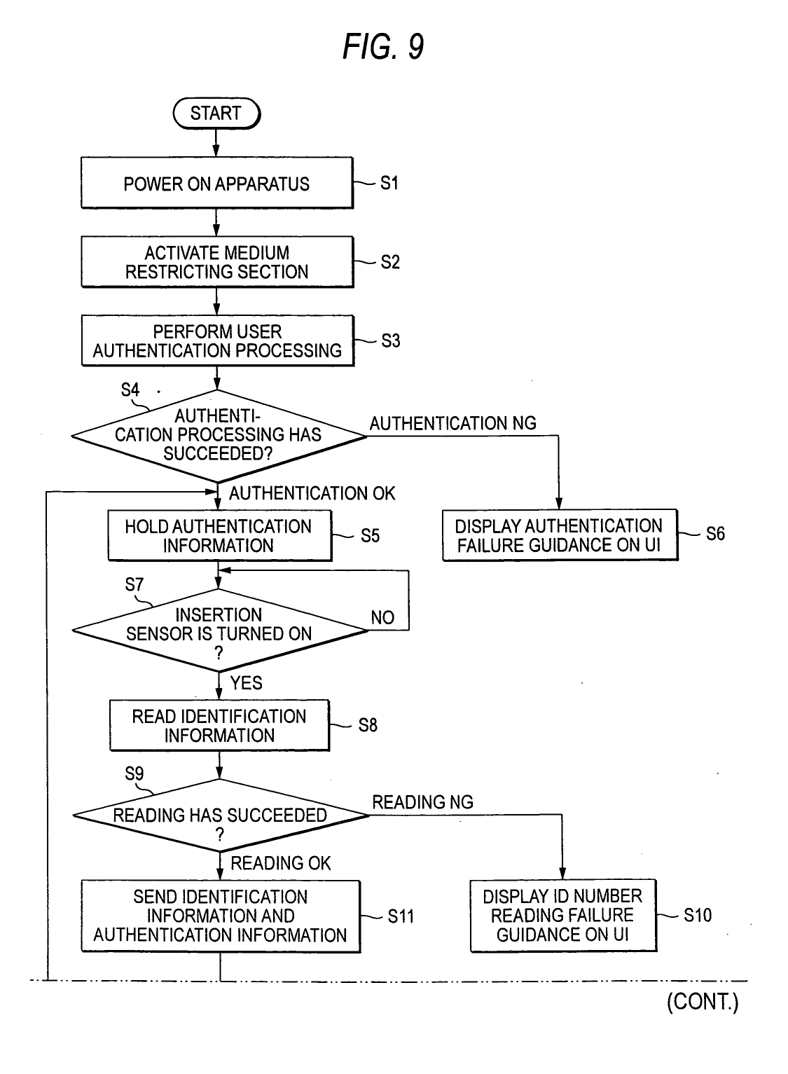

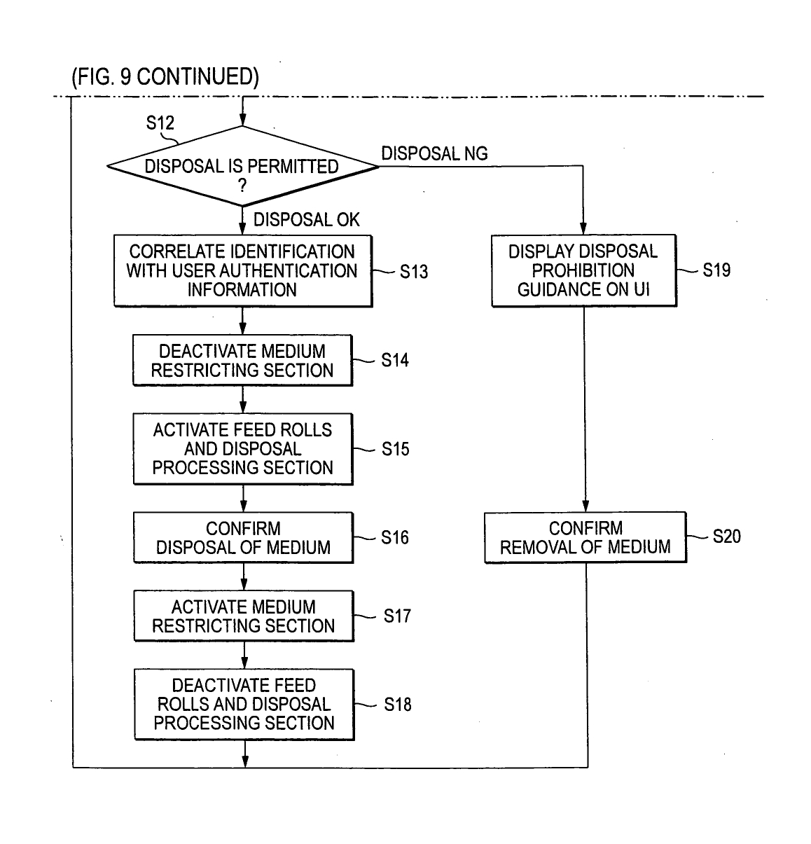

FIG. 9 is a flowchart of a processing procedure which is followed when the manual-feed-type document disposal apparatus 3 disposes of a document. The document disposal apparatus 3 has an ordinary disposal mode in which code information (document ID) is not read and a scanning disposal mode in which code information is read. The flowchart of FIG. 9 shows a processing procedure of the scanning disposal mode which is followed in the case where the scanning disposal mode is set as a mode to be employed in an initial state, that is, immediately after the document disposal apparatus 3 is powered on. It is also possible to set the ordinary disposal mode as a mode to be employed in an initial state, that is, immediately after the document disposal apparatus 3 is powered on.

Switching to the ordinary disposal mode can be made by a disposal mode switching section (not shown). In the ordinary disposal mode, when the start button on the operation panel 31 is depressed by a user in a state that the document disposal apparatus 3 is in a standby state, the document disposal control section 36 instructs the stopper driving section 33, the feeder driving section 34, and the shredder driving section 35 to start driving, whereby the stopper 20 is opened and driving of the feed rolls 21 and 22 and the shredder unit 24 is started. As a result, if the user of the document disposal apparatus 3 places a document as a subject of disposal on the document tray unit 17 and inserts it inward, the head of the document is nipped by the feed rolls 21 and the document is pulled into the apparatus 3. The document is transported as it is by the feed rolls 21 and 22 and shredded by the shredder unit 24.

If the stop button on the operation panel 31 is depressed by the user after the above-mentioned depression of the start button on the operation panel 31 or if a prescribed time has elapsed from the depression of the start button, the document disposal control section 36 instructs the stopper driving section 33, the feeder driving section 34, and the shredder driving section 35 to stop the driving, whereby the stopper 20 is returned to the original projected state and the driving of the feed rolls 21 and 22 and the shredder unit 24 is stopped. The document disposal apparatus 3 is thus returned to a standby state.

On the other hand, in the scanning disposal mode, if a user of the document disposal apparatus 3 places a document as a subject of disposal on the document tray unit 17 and inserts it inward, the insertion sensor 18 is turned on immediately before the head of the document butts against the stopper 20. If a QR code is printed on the document as the subject of disposal, the user should insert it in such a manner that its QR-code-printed surface is made the top surface.

The procedure of FIG. 9 will be described below. When the document disposal apparatus 3 is powered on at step S1, since the scanning disposal mode is set in the initial state, even if a document as a recording medium to be disposed of is placed on the document tray unit 17 which is part of the medium transport passage of the document disposal apparatus 3, at step S2 the document thus placed is temporarily rendered in such a state as to be prevented from being transported to the shredder unit 24 (disposal processing section) because of the projection of the stopper 20 (recording medium restricting section).

At step S3, a user holds an IC card containing his or her authentication information over the IC card reader 42 of the document disposal apparatus 3 and authentication processing for personal identification is performed. At step S4, it is judged whether the authentication processing for personal identification has succeeded. If the authentication processing has succeeded (step S4: authentication OK), the authentication information is held at step S5. If the authentication processing has failed (step S4: authentication NG), at step S6 an “authentication failure guidance” to the effect that If the authentication processing has failed is displayed on the operation panel 31.

If it is judged at step S4 that the authentication processing has succeeded, at step S7 the document disposal control section 36 continuously monitors an output signal of the insertion sensor 18 (i.e., its on/off state). If the insertion sensor 18 is turned on as a result of insertion of the document by the user, the document disposal control section 36 gives a bar code reading instruction to the bar code reader 32. At step S8, the bar code reader 32 reads the QR code (document identification information) printed on the document in response to the reading instruction.

At step S9, the document disposal control section 36 judges whether the reading of the QR code which contains the document identification information has succeeded. Whether the reading of the QR code has succeeded is judged by judging whether the QR code printed on the document has been decoded correctly by the bar code reader 32. Exemplary situations that may cause the bar code reader 32 to fail in reading the QR code are that the QR code printed on the document is stained or damaged severely, no QR code is printed on the document, and the QR code of the document is located outside the code reading area E (see FIG. 5) because of an improper manner of insertion of the document. If it is judged at step S9 that the reading of the QR code has failed, at step S10 a reading failure guidance which was prepared in advance is displayed on the operation panel 31. An exemplary reading failure guidance is “A code reading error has occurred. Please pull out the document.”

If the reading of the QR code has succeeded (step S9: yes), at step S11 the document disposal control section 36 inquires of the document management apparatus 2 whether disposal of the document that is identified by the document ID contained in the QR code is permitted. This is done by generating a disposal permission inquiry message in which the document ID contained in the QR code read by the bar code reader 32 and the authentication information held at step S5 are designated and sending this inquiry message to the document management apparatus 2 via the network interface 16 (communication section) and the network 4. That is, the document disposal permission inquiry is an inquiry as to whether the user who has been authenticated through the IC card reader 42 is permitted to dispose of the document that is identified by the document ID designated in the inquiry. The document management apparatus 2 (recording medium management apparatus) collates the received QR code and authorization information with the contents of the database section 14, and sends disposal permission/prohibition information to the document disposal apparatus 3.

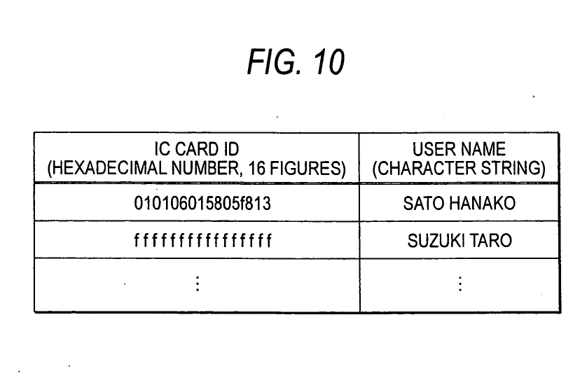

In the document management apparatus 2 which has received the inquiry message, the document management control section 15 judges, on the basis of the document ID and the authentication information designated in the inquiry message, whether to permit the document disposal apparatus 3 to dispose of the document or prohibit the document disposal apparatus 3 from disposing of the document. First, in the document management apparatus 2, the search section 13 searches a user information table (see FIG. 10) stored in the database section 14 to check whether the user who is correlated with the IC card (personal identification section) identification number that has been received as the authentication information is registered therein. If the identification information concerned is registered, the document management control section 15 judges that the user is registered. If the user who is correlated with the IC card identification number is registered, the search section 13 conducts a search to determine whether the designated document ID corresponding to the QR code is registered in the document management table. If the document ID concerned exists in the document management table, the document management control section 15 checks a “document storage period” that is registered as corresponding to the document ID concerned. If the date of reception of the document disposal permission inquiry from the document disposal apparatus 3 is after the document storage period, the document management apparatus 2 returns, to the document disposal apparatus 3, a reply message to the effect that disposal of the document is permitted. If the date of reception of the document disposal permission inquiry from the document disposal apparatus 3 is not after the document storage period, the document management apparatus 2 returns, to the document disposal apparatus 3, a reply message to the effect that disposal of the document is prohibited.

In the above exemplary embodiment, the user information table and the document management table are not correlated with each other, that is, they are independent of each other. However, a modification is possible in which the user information table and the document management table are correlated with each other and whether to permit disposal of a document is judged according to those tables. Assume a case that Mr. A and Mr. B are registered in the user information table and only Mr. A is registered as a person who is permitted to dispose of document X. In this case, Mr. B is not permitted to dispose of document X even if he is authenticated through an IC card.

Where a document ID and a disposal-permitted person are correlated with each other to form a disposal permission condition, when one has generated a document using the document generation apparatus 1 the generator may be registered as a disposal-permitted person in the document management apparatus 2 so as to be correlated with a document ID.

In the above exemplary embodiment, it is judged whether a user corresponding to authentication information is registered. Alternatively, a person, an organization, a section, a group, or the like may be set as what corresponds to authentication information on the basis of which whether to permit disposal is judged. For example, a section chief and a person in charge may be permitted to dispose of different kinds of documents (i.e., a disposal document filter is provided between them). More specifically, where director C is a generator of document Y, group F consisting of director C and his or her secretary D may be registered as a group of persons who are permitted to dispose of document Y. Furthermore, conditions relating to the period and the amount of money according to which whether to permit disposal of a document may be changed on a user-by-user basis.

Although in the above exemplary embodiment the document disposal apparatus 3 sends identification information and authentication information together, the document disposal apparatus 3 may send authentication information first upon its acquisition. The document management apparatus 2 judges whether the received authentication information is registered in the database section 14. If the authentication information is not registered in the database section 14, the document management apparatus 2 returns a reply to the effect that the authentication information is not registered or disposal of the document is not permitted. Receiving the reply, the document disposal apparatus 3 refrains from performing disposal processing and displays, on the operation panel 31, a guidance to the effect that disposal processing cannot be performed. As a result, the user of the document disposal apparatus 3 can recognize, immediately, that is, before inserting the document, that disposal processing cannot be performed thereon. If the authentication information is registered in the database section 14, the document management apparatus 2 sends, to the document disposal apparatus 3, disposal permission condition data including identification information such as document IDs corresponding to the authentication information. Assume a specific case that authentication information of Mr. A is sent from the document disposal apparatus 3 to the document management apparatus 2 and the authentication information of Mr. A is registered (exists) in the document management apparatus 2. In this case, the document management apparatus 2 sends, to the document disposal apparatus 3, disposal permission conditions such as document IDs of documents that Mr. A is permitted to dispose of and storage periods of those documents. The document disposal apparatus 3 holds those disposal permission conditions received. As a result, when a document is inserted and its identification information is acquired, the document disposal apparatus 3 compares the identification information with the disposal permission conditions held by itself and can thereby judge immediately whether disposal of the document is permitted, without the need for sending the identification information to the document management apparatus 2. This measure is particularly effective in a case that a user of the document disposal apparatus 3 disposes of plural documents. That is, if the system is configured so that the document disposal apparatus 3 continues to hold disposal permission conditions even after disposal of a first document, the user can immediately dispose of second and following documents according to the conditions being held without the need for inquiring of the document management apparatus 2 about a disposal permission condition each time. The disposal permission conditions thus held may be canceled if the next document is not inserted for a prescribed time after disposal of the preceding document.

The document disposal control section 36 receives, via the network interface 37, the reply message returned from the document management apparatus 2. At step S12, the document disposal control section 36 judges whether the reply message returned in response to the inquiry from the document disposal apparatus 3 itself is to permit disposal of the document. If the reply message is to permit disposal of the document, at step S13 the document disposal control section 36 issues an instruction to correlate the identification information with the authentication information and resulting correlated information is stored as history information together with other information. The information in which the identification information is correlated with the authentication information is stored in another apparatus on the network 4 (e.g., the document management apparatus 2) as history information. History information may be stored in a detachable device (e.g., USB memory). If the reply message is to permit disposal of the document as mentioned above, at step S14 the document disposal control section 36 displays a disposal permission guidance (guide message; prepared in advance) on the operation panel 31 and opens the stopper 20 by instructing the stopper driving section 33 to do so. At the same time, the document disposal control section 36 instructs the feeder driving section 34 to start rotating the feed rolls 21 and 22 and, in response, the feeder driving section 34 starts rotating the feed rolls 21 and 22 (step S15). An exemplary disposal permission guidance is “The stopper will be opened to dispose of this document. Please insert the document further inward.”

If the user inserts the document further according to the guidance displayed on the operation panel 31, the head of the document butts into the nip portion of the feed rolls 21 and the document is fed downstream along the document transport passage as the feed rolls 21 rotate. The document thus fed by the feed rolls 21 is passed to the feed rolls 22 which are located downstream of the feed rolls 21 in the transport direction, and is then transported to the shredder unit 24 as the feed rolls 22 rotate. When the tail of the document passes the sensing position of the insertion sensor 18 and the insertion sensor 18 is thereby switched from the on state to an off state, the document disposal control section 36 instructs, with preset timing (e.g., at a time point when the tail of the document passes the feed rolls 21), the stopper driving section 33 to return the stopper 20 to the original state (projected state) and the stopper 20 is thereby done so.

When the head of the document passes the sensing position of the passage sensor 23 while the document is being transported by the feed rolls 22 and the passage sensor 23 is thereby switched from the off state to an on state, the document disposal control section 36 instructs the shredder driving section 35 to start driving and, in response, the shredder driving section 35 starts driving the shredder unit 24. As a result, the document that has been fed by the feed rolls 22 is pulled into the shredder unit 24 as it is and shredded (disposed of) by the shredder unit 24.

When the tail of the document passes the sensing position of the passage sensor 23 and the passage sensor 23 is thereby switched from the on state to an off state, at step S16 the document disposal control section 36 generates disposal history information including the document ID of the document for which the document disposal permission was received a short while ago, a disposal completion flag, a disposal date (or date and time), a disposer, etc. after a lapse of a prescribed time (more specifically, a time that is taken until the tail of the document is pulled into the shredder unit 24 and the entire document is shredded) from the time point when the passage sensor 23 was turned off. The disposer information may be user information that was retrieved by the authenticating section at the time of booting on the basis of the authentication information. The document disposal control section 36 sends the generated disposal history information and a disposal completion notice indicating that the disposal of the document concerned has been completed to the document management apparatus 2 in the form of a message. The disposal completion notice message is sent to the document management apparatus 2 via the network interface 37 and the network 4. In the document management apparatus 2 which has received the disposal completion notice message from the document disposal apparatus 3, a date of reception of the message is registered so as to be added to the disposal history information corresponding to the document ID that is designated in the message in the column of the “document disposal date”. That is, correlating the identification information attached to the recording medium with the authentication information of the user who is going to perform disposal work makes it possible to later clarify who disposed of the document, and storing related history information makes it possible to later check whether the disposal work was performed correctly. At step S17, the stopper 20 (recording medium restricting section) is projected to establish a temporary state that a document cannot be transported to the shredder unit 24 (disposal processing section). At step S18, the feeder driving section 34 stops rotating the feed rolls 21 and 22.

If disposal of the document is not permitted by the document management apparatus 2 at step S12, at step S19 a disposal prohibition guidance which was prepared in advance is displayed on the operation panel 31. An exemplary disposal prohibition guidance is “Disposal of this document is prohibited. Please pull out the document.” When the disposal completion notice message at step S16, the document disposal apparatus 3 immediately returns to a standby state. On the other hand, when the reading failure guidance is displayed at step S10 or the disposal prohibition guidance is displayed at step S19, the document disposal apparatus 3 returns to a standby state after the insertion sensor 18 is switched from the on state to an off state (i.e., after the user removes the document from the document tray unit 17 and the removal of the document is confirmed at step S20).

In the above exemplary embodiments, a document for which reading of a QR code fails and a document for which disposal permission is not obtained from the document management apparatus 2 are ejected to a common (same) ejection tray unit. However, the invention is not limited to such a case. A document for which reading of a QR code fails and a document for which disposal permission is not obtained from the document management apparatus 2 may be ejected to different ejection tray units by employing a gate member for switching between document transport passages (directions).

In the above document management system, document IDs assigned to documents are managed by the document management apparatus 2 so as to be correlated with “document storage periods,” respectively. In disposing of a document using the document disposal apparatus 3, a QR code printed on the document as a subject of disposal is read by the bar code scanner 19 and the document ID contained in the QR code is acquired. An inquiry as to whether disposal of the document identified by the document ID is permitted is sent to the document management apparatus 2. If a reply to the inquiry section that disposal of the document is permitted, the document disposal apparatus 3 performs disposal processing on the document. Therefore, only documents whose storage periods have expired can be disposed of reliably unlike in the conventional case in which a person in charge is required to check whether disposal of each document is permitted. Furthermore, erroneous discard of a document due to a human check error can be avoided.

Since a document ID assigned to a document generated by using the document generation apparatus 1 is managed by the document management apparatus 2 so as to be correlated with a “document storage period,” the document can be managed all the way from its generation to disposal.

When a document has been disposed of (i.e., shredded) by the document disposal apparatus 3, a disposal completion notice message in which its document ID is designated is sent to the document management apparatus 2 and, upon reception of the message, the document management apparatus 2 registers a document disposal date etc. in the document management table as disposal history information corresponding to the document ID. Therefore, the actual date (preferably, date and time) of disposal of the document can be kept in storage as history information in association with the fact that the document was disposed of. It is also possible to keep in storage, as another piece of disposal history information, a user ID or the like of a person (document disposer) who was in charge of the disposal of the document. This makes it possible to later check when and by whom a document that is identified by a certain document ID was disposed of.

When a document is generated (printed) by the document generation apparatus 1, a date (preferably, date and time) of generation of the document and a user ID or the like of a person (document generator) who is in charge of the generation of the document, together with a document ID of the document, are registered in the document management table of the document management apparatus 2. This makes it possible to later check when and by whom a document that is identified by a certain document ID was generated.

The manual-feed-type document disposal apparatus 3 can dispose of (a bundle of) plural document sheets at one time in such a manner that they are kept stapled. On the other hand, an automatic-feed-type document disposal apparatus can dispose of a document while judging, on a document-by-document basis, whether disposal is permitted without requiring any further manipulation by a user after the document is set on a document tray unit and a start button is pushed.

Although in the above exemplary embodiment a QR code containing a document ID is printed on a document, the invention is not limited to such a case. For example, numerals, symbols, etc. representing a document ID may be printed on a document. Furthermore, the method for attaching a document ID to a document is not limited to printing. For example, a document ID may be attached to a document by sticking a label to the document.

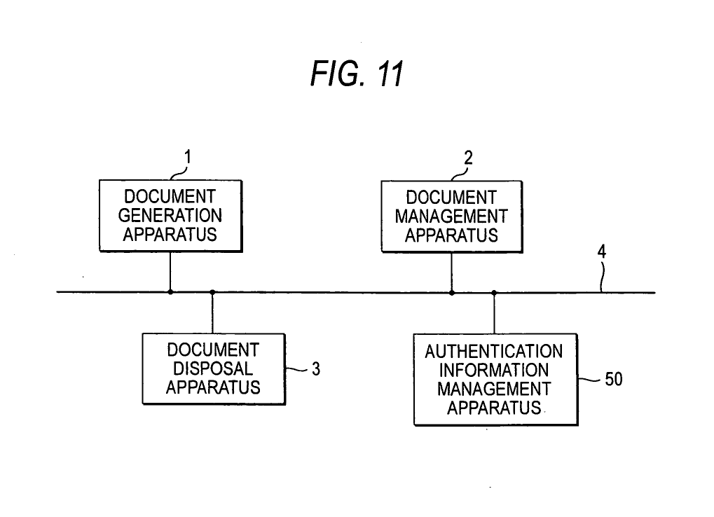

In the above exemplary embodiment, whether disposal of a recording medium is permitted or prohibited is judged by searching the database section 14 of the document management apparatus 2 on the basis of identification information of the recording medium and authentication information that the document management apparatus 2 receives from the document disposal apparatus 3 (see FIG. 1). However, another exemplary embodiment is possible in which as shown in FIG. 11 a database relating to authentication information is stored in a separate authentication information management apparatus 50. In this exemplary embodiment, authentication information acquired by the document disposal apparatus 3 is sent to the document management apparatus 2 and the document management apparatus 2 which has received the authentication information acquires personal information (e.g., a post, a section to which the user belongs to, and details of work) relating to the authentication information by searching the authentication information management apparatus 50. When a document to be disposed of is thereafter inserted into the document disposal apparatus 3 and its identification information is read, the document disposal apparatus 3 sends the identification information to the document management apparatus 2. The document management apparatus 2 which has received the identification information judges whether to permit disposal of the document on the basis of the previously acquired personal information relating to the authentication information and the identification information (e.g., a document ID).

More specifically, assume that personal information that the name is Mr. A, the post is a department manager, the section or department he belongs to is the accounting department, and the details of work are salary management is acquired on the basis of authentication information corresponding to identification information of an IC card through which the user has been authenticated, and that a disposal permission condition “the post is a department manager or higher or the user belongs to the accounting department” is set for document A in the database section 14 of the document management apparatus 2 in advance. If a read-out document ID as identification information is of document A, the document management apparatus 2 judges that disposal of document A is permitted. Separately managing information (e.g., an employee database) relating to authentication information in this manner facilitates the management of the databases because it is not necessary to reconstruct the entire database. The procedure that the document management apparatus 2 first makes a judgment relating to authentication information and holds disposal permission conditions that are based on a result of the judgment makes it possible to immediately make a disposal permission judgment according to the disposal permission conditions when the document disposal apparatus 3 acquires identification information. This measure is particularly effective in a case that a user of the document disposal apparatus 3 disposes of plural documents. That is, if the system is configured so that the document management apparatus 2 continues to hold disposal permission conditions even after disposal of a first document, the user can immediately dispose of second and following documents without the document management apparatus 2's having to inquire of the authentication information management apparatus 50 each time.

Although the above exemplary embodiments are directed to the case that the document disposal apparatus 3 is of a shredder type, the invention is not limited to such a case. The document disposal apparatus may be such as to dispose of a document by firing, melting, or the like or to merely transport a document to a disposal box.

Although the above exemplary embodiments are directed to the case that recording media to be subjected to disposal processing are documents, the invention is not limited to such a case. Recording media to be subjected to disposal processing may be CD-Rs, DVD-Rs, IC cards, or the like on which secret information is recorded.

Although the above exemplary embodiments are directed to the case that the identification information is a document ID obtained by recognizing a QR code, the invention is not limited to such a case. The identification information may be an attribute (e.g., a secrecy level, a type, or a date of generation) of a document. Although the above exemplary embodiments are directed to the case that identification information is directly recorded on a document to be disposed of as in the case of a QR code, the invention is not limited to such a case. Identification information may be recorded in an IC card or on a document that is different from a document to be disposed of, and read from it. Or identification information may directly be input to the document disposal apparatus.

Although in the above exemplary embodiments the document management apparatus 2 and the document disposal apparatus 3 are separate apparatus, they may be integrated together if necessary.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A disposal apparatus comprising:
a disposal processing section that disposes of a recording medium;
an authentication information acquiring section that acquires authentication information to be used for authenticating a user of the disposal apparatus; and
a disposal processing control section that permitting or prohibiting disposal of the recording medium by the disposal processing section based on the authentication information acquired by the authentication information acquiring section.

2. The disposal apparatus according to claim 1, further comprising a restricting section that restricts insertion of the recording medium into the disposal processing section,
wherein the disposal processing control section performs a control that permits or prohibits disposal of the recording medium by the disposal processing section by controlling operation of the restricting section based on the authentication information acquired by the authentication information acquiring section.

3. The disposal apparatus according to claim 1, further comprising a sending section that sends the authentication information acquired by the authentication information acquiring section to a management apparatus,
wherein the disposal processing control section performs a control for permitting or prohibiting disposal of the recording medium by the disposal processing section based on a reply that is sent from the management apparatus in response to the authentication information sent by the sending section and that indicates permission or prohibition of disposal processing.

4. The disposal apparatus according to claim 1, further comprising an identification information acquiring section that acquires identification information for identification of the recording medium,
wherein the disposal processing control section performs a control for permitting or prohibiting disposal of the recording medium by the disposal processing section based on the identification information acquired by the identification information acquiring section and the authentication information acquired by the authentication information acquiring section.

5. The disposal apparatus according to claim 1, further comprising: a sending section that sends the authentication information acquired by the authentication information acquiring section to a management apparatus, and a reply holding section that holds a reply that is sent from the management apparatus in response to the authentication information sent by the sending section,
wherein the disposal processing control section performs a control for permitting or prohibiting disposal of the recording medium by the disposal processing section based on the identification information acquired by the identification information acquiring section and the reply held by the reply holding section.

6. The disposal apparatus according to claim 1,
wherein the identification information is a document ID.

7. The disposal apparatus according to claim 1,
wherein charging for the disposal is performed based on the authentication information.

8. A disposal system comprising: a disposal apparatus comprising a disposal processing section that disposes of a recording medium; and a management apparatus that performs disposal management on the recording medium,
wherein the disposal apparatus further comprises:
an authentication information acquiring section that acquires authentication information to be used for authenticating a user of the disposal apparatus;
a sending section that sends the authentication information acquired by the authentication information acquiring section to a management apparatus; and
a disposal processing control section that permits or prohibits disposal of the recording medium by the disposal processing section based on a reply that is sent from the management apparatus in response to the authentication information sent by the sending section and that indicates permission or prohibition of disposal processing, and
wherein the management apparatus comprises a reply sending section that sends the reply to the disposal apparatus.

9. The disposal system according to claim 8,
wherein the disposal apparatus further comprises a restricting section that restricts insertion of the recording medium into the disposal processing section; and
the reply sent by the reply sending section of the management apparatus is a control signal for the restricting section.

10. The disposal system according to claim 8,
wherein the disposal apparatus further comprises an identification information acquiring section that acquires identification information for identification of the recording medium,
the sending section of the disposal apparatus sends the identification information acquired by the identification information acquiring section to the management apparatus, and
the reply sending section of the management apparatus sends a reply indicating permission or prohibition of disposal processing to the disposal apparatus based on the identification information and the authentication information sent by the sending section of the disposal apparatus.

11. The disposal system according to claim 8,
wherein the disposal apparatus further comprises identification information acquiring section that acquires identification information for identification of the recording medium; and
the disposal processing control section performs a control for permitting or prohibiting disposal of the recording medium by the disposal processing section based on the reply from the management apparatus and the identification information acquired by the identification information acquiring section.

12. The disposal system according to claim 8, further comprising an authentication information management apparatus that manages authentication-information,
wherein the management apparatus acquires information relating to the authentication information from the authentication information management apparatus based on the authentication information sent by the sending section of the disposal apparatus,
wherein the reply sending section sends a reply indicating permission or prohibition of disposal processing to the disposal apparatus based on the acquired information relating to the authentication information and the identification information sent by the sending section.

13. A disposal method for disposing of a recording medium, comprising:
acquiring authentication information to be used for authenticating a user of a disposal apparatus; and
performing a control for permitting or prohibiting disposal of the recording medium based on the acquired authentication information.

14. A disposal method for disposing of a recording medium, comprising:
acquiring authentication information to be used for authenticating a user of a disposal apparatus;
acquiring identification information for identification of the recording medium; and
performing a control for permitting or prohibiting disposal of the recording medium based on the acquired authentication information and the acquired identification information.
